(19) United States
(12) Patent Application Publication
(10) Pub. No.: US 2013/0238612 A1
(43) Pub. Date: Sep. 12, 2013

(54) METHOD AND APPARATUS FOR PROVIDING REFINED SEARCH RESULTS FOR A QUERY BASED ON ONE OR MORE USER INTERACTIONS

(71) Applicants: Jason C. TSONGAS, Rochester, NY (US); Matthew O. SCRAFFORD, Fairport, NY (US); Daniel A. COCCIA, Fairport, NY (US)

(72) Inventors: Jason C. TSONGAS, Rochester, NY (US); Matthew O. SCRAFFORD, Fairport, NY (US); Daniel A. COCCIA, Fairport, NY (US)

(73) Assignee: XEROX CORPORATION, Norwalk, CT (US)

(21) Appl. No.: 13/415,542

(22) Filed: Mar. 8, 2012

(51) Int. Cl. G06F 17/30

(52) U.S. Cl. 707/723; 707/766; 707/E17.005; 707/E17.017

(57) ABSTRACT

An approach is provided for determining refined search results for a query. The approach involves processing one or more interactions of a user with one or more content items to cause, at least in part, an accumulation of the one or more interactions of the user. The approach also involves processing the accumulation of the one or more interactions to determine one or more interaction patterns. The approach additionally involves determining one or more user preferences based, at least in part, on the one or more interaction patterns. The approach further involves causing, at least in part, a scope of one or more search results for a query to be based, at least in part, on the one or more user preferences.

### FIELD OF DISCLOSURE

The disclosure relates to refining query search results and various data sets based on perceived user preferences that are discerned at least from one or more user interactions with content items.

### BACKGROUND

Service providers and device manufacturers (e.g., wireless, cellular, networked, etc.) are continually challenged to deliver value and convenience to consumers by, for example, providing compelling network services. One area of interest involves providing efficient and accurate content search results. Users often do not have the time or the skill set to effectively search content so as to yield results that are aligned with their expected results. For example, a typical content browsing system may return results for a query based on specific inputs and query scripts, or suggest items to a user based on a prediction that the user would be interested in the item even if that user has never considered the item before. Such predictions historically have been based on collaborative filters that rely on large amounts of user data (e.g., historical explicit rating and explicit preference information). However, such user data is often not available or has not been collected with respect to a user's particular interaction with various content items, services or applications.

### SUMMARY

Therefore, there is a need for an approach that provides refined search results for a query based on one or more user interactions.

According to one embodiment, a method comprises processing one or more interactions of a user with one or more content items to cause, at least in part, an accumulation of the one or more interactions of the user. The method also comprises processing the accumulation of the one or more interactions to determine one or more interaction patterns. The method additionally comprises determining one or more user preferences based, at least in part, on the one or more interaction patterns. The method further comprises causing, at least in part, a scope of one or more search results for a query to be based, at least in part, on the one or more user preferences.

According to another embodiment, an apparatus comprises at least one processor, and at least one memory including computer program code for one or more computer programs, the at least one memory and the computer program code configured to, with the at least one processor, cause, at least in part, the apparatus to process one or more interactions of a user with one or more content items to cause, at least in part, an accumulation of the one or more interactions of the user. The apparatus is also caused to process the accumulation of the one or more interactions to determine one or more interaction patterns. The apparatus is additionally caused to determine one or more user preferences based, at least in part, on the one or more interaction patterns. The apparatus is further caused to cause, at least in part, a scope of one or more search results for a query to be based, at least in part, on the one or more user preferences.

According to another embodiment, a computer-readable storage medium carries one or more sequences of one or more instructions which, when executed by one or more processors, cause, at least in part, an apparatus to process one or more interactions of a user with one or more content items to cause, at least in part, an accumulation of the one or more interactions of the user. The apparatus is also caused to process the accumulation of the one or more interactions to determine one or more interaction patterns. The apparatus is additionally caused to determine one or more user preferences based, at least in part, on the one or more interaction patterns. The apparatus is further caused to cause, at least in part, a scope of one or more search results for a query to be based, at least in part, on the one or more user preferences.

Exemplary embodiments are described herein. It is envisioned, however, that any system that incorporates features of any apparatus, method and/or system described herein are encompassed by the scope and spirit of the exemplary embodiments.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing refined search results for a query based on one or more user interactions, according to one embodiment;

FIG. 2 is a diagram of the components of a query refinement platform, according to one embodiment;

FIG. 3 is a flowchart of a process for providing refined search results for a query based on one or more user interactions, according to one embodiment;

FIG. 4 is a diagram of a user interface utilized in the processes of FIG. 3, according to various embodiments;

FIG. 5 is a diagram of user interfaces utilized in the processes of FIG. 3, according to various embodiments; and

FIG. 6 is a diagram of a chip set that can be used to implement an embodiment of the invention.

### DESCRIPTION OF SOME EMBODIMENTS

Examples of a method, apparatus, and computer program for providing refined search results for a query based on one or more user interactions are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “content” refers to any item of interest such as, for example but not limited to, any person, place, thing, data set, data entry, restaurant, coupon, event, item for sale, store, news article, internet link, movie, television show, travel destination, etc.

The term “context” refers to data that indicates the state of a device or the inferred state of a user of the device, or both. The states indicated by the context are, for instance, described according to one or more “context parameters” including time, recent applications running on the device, recent World Wide Web pages presented on the device, keywords in current communications (such as emails, SMS messages, IM messages), current and recent locations of the device (e.g., from a global positioning system, GPS, or cell tower identifier), movement, activity (e.g., eating at a restaurant, drinking at a bar, watching a movie at a cinema, watching a video at home or at a friend's house, exercising at a gymnasium, traveling on a business trip, traveling on vacation, etc.), emotional state (e.g., happy, busy, calm, rushed, etc.), interests (e.g., music type, sport played, sports watched), contacts, or contact groupings (e.g., family, friends, colleagues, etc.), among others, or some combination.

As used herein, the term “interaction” refers to any physical influence by a human upon a user interface of any kind relevant to a query, even if the query is undefined at any time during the total course of the physical influence. Such influence may be by way of, for example, by not limited to a mouse movements, finger movements on a touch screen, scrolling, etc. Alternatively, or in addition to such physical influence, interactions may be by way of voice, gesture, haptic response, and the like.

As used herein, the term “processing” refers to any activity associated with carrying out a series of operations on a data set by way of a processor, for example, to produce a desired result or cause one or more subsequent operations or results.

As used herein, the term “pattern” refers to a combination of qualities, acts, tendencies, etc., forming a consistent or characteristic arrangement, for example, that may be analyzed and considered to indicate a user habit and/or preference.

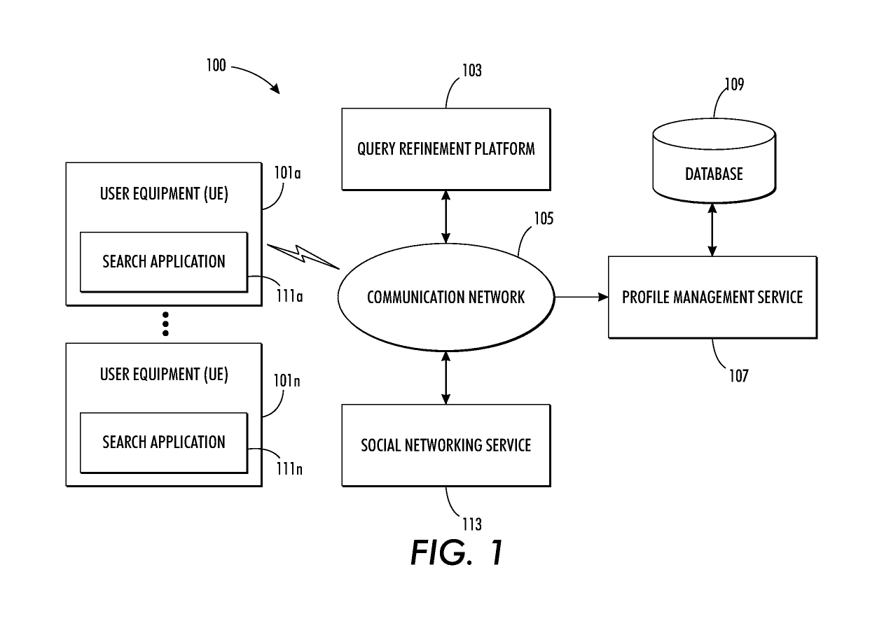

FIG. 1 is a diagram of a system capable of providing refined search results for a query based on one or more user interactions, according to one embodiment.

Users are often overwhelmed by large data sets such as spreadsheets having seemingly endless data entries, by countless products and services offered by various e-commerce systems, or by infinite search results for any general information query. Currently when a user searches through a large amount of data, the user either manually scans for details they are interested in, or adds query filters to refine the quality of a content search. For example, a user may use a browser to search for cars or hotels, or a user may search a spreadsheet that includes various expenditures to find a value that raises a red flag.

Conventional users often lack the skills necessary to perform a perfect search or query that returns results in accordance with their particular interests or intended goals. Many content browsers require complex scripts to search content or require a user to manipulate excessive filtering mechanisms by way of various user interfaces to refine their search results.

Recommender systems are becoming a salient part of most e-commerce platforms. Collaborative Filtering (CF) is a core technology of most modern recommender systems, which analyzes relationships between users and interdependencies among products to identify new user-item associations. Most CF based recommender systems rely on ratings that reflect a users' specific preferences about items of interest. Most methods require explicit feedback such as a numerical, letter or a star rating-scale that may be received from a user in the form of numbers between 1 and 5 from strongly reject to strongly accept, or letter ratings as “A+,” “A,” “A−,” “B+,” “B,” . . . “F,” for example. While explicit feedback is a direct way to understand user preference, most users do not go through the process of indicating their explicit preferences and/or ratings.

Other CF platforms utilize implicit feedback that is usually received as binary values (0 or 1), e.g., “bought”-vs-“didn't buy”, “viewed”-vs-“didn't view.” For example, if a user is viewing a website, he may or may not buy an item for sale. An implicit feedback would be a simple yes or no indication as to whether the user is interested in the particular item. But, other more in-depth feedback may be available to more finely tune a user's interest in a content item based on the user's interaction with the content item beyond that which is available by a simple binary collection of data.

To address this problem, a system 100 of FIG. 1 introduces the capability to provide refined search results for a query based on one or more user interactions. The system 100 may, for example, improve search results dynamically based on a perception of the users preferences rather than requiring users to enter explicit details into a content search, thereby alleviating the need for users to learn the various methods used by different applications such as content browsers or data query builders, and instead let their actions lead to the results they are looking for.

As shown in FIG. 1, the system 100 comprises one or more user equipment (UE) 101a-101n (hereinafter collectively referred to as UE 101) having connectivity to a query refinement platform 103, a profile management service 107, a database 109 and a social networking service 113 via a communication network 105. The UE 101 may also comprise a search application 111a-111n for each respective UE 101 (hereinafter collectively referred to as search API 111).

According to various embodiments, the query refinement platform 103 and/or the profile management service may be remote from the UE 101, but it should be understood that the query refinement platform 103 and/or the profile management service 107 may alternatively, or in addition to being remote from the UE 101, be onboard the UE 101. Similarly, the search API 111, though illustrated as being onboard the UE 101 may alternatively, or in addition to being onboard the UE 101, be remote from the UE 101.

By way of example, the communication network 105 of system 100 includes one or more networks such as a wired data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), WiGig, wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one or more embodiments, the search API may be a standalone application or a plugin, for example, to various content browser applications that the UE 101 may have access to. Users may not even be aware of the presence of the search API 111. But, a user may have an option to, by way of a settings preference available in the UE 101, any content browser, or the search API 111, to enable or disable the search API. Accordingly, when enabled, users may browse content ignorant of any particular preferences they have regarding various content that the user may not typically include in his search criteria. For example, the search API 111 allows for recognition of these underlying preferences and adjusts a user's search preferences accordingly.

In one or more embodiments, the search API 111 detects subtle user patterns such as particular detected interactions with content that may be understood to adjust search criteria. According to various embodiments, such interactions that may be detected may include, for example, a speed of mouse/pointer scrolling, a selection focus, an amount of time focused on a particular page, scrolling speed, time delays when reviewing data, page up/down patterns, mouse/pointer hovering patterns, etc. Additionally, interactions may include specific interactions with content items on a web page such as “view,” “click,” “add to wish list,” “add to cart,” or “purchase,” for example. Further, some users might have interactions that correspond to a different level of interest such as “do not recommend,” “recommend but not view,” “forward,” “add to favorite list,” “join a group,” “grab a coupon,” etc.

All of these various elements may be monitored by the search API 111 and communicated to the query refinement platform 103 to identify discernable patterns in user behavior that could be used to further refine lists/searches. In other words, search results may be narrowed based on implicit user activity. Over time, the search API 111 may communicate various nuances of how a user interacts with similar or related content items. The query refinement platform 103, accordingly, adjusts any search results that may be generated for a user's content query in view of the users discernable patterns. The search API 111, will then present search results that are in accordance with the user's perceived interests based on his interactions rather than limiting a query to a written query script or generic filtering models that require explicit user direction. It should be noted, however, that the search API 111 may be operative as a standalone feature for refining a query, or it may be operative in conjunction with any existing filtering mechanisms that may be features of any content browsing application.

For example, the search API 111 may detect a user interaction pattern as a user scrolls through results presented in response to a query for cars available for purchase by way of an e-commerce system. The search API 111 detects the speed at which the user scrolls through various content items. For example, the user may slow his scrolling at blue and black cars. The search API 111 may send this information to the query refinement platform 103, and based on this information which would seemingly indicate the user is interested in blue and black cars over other colors, the query refinement platform 103 would further refine the query to return results that are directed to dark colored cars. For example, this further refinement may lead to only blue and black cars being presented to the user by the search API 111.

Any detected user interaction pattern may be considered in this example to indicate a user interest or preference for any topic that may further refine a search for a car. The detected user interactions may cause the query refinement platform 103 to perceive a user's preferences for domestic vs. foreign cars, dark colored cars vs. light colored cars, newer cars vs. older cars, convertible cars vs. hard top cars, sports car vs. sedan, etc. These preferences assist in refining the search results in the same way an explicit filtering mechanism or that an explicitly entered a query string would refine any search results. However, a user having access to the search API 111 and the query refinement platform 103 does not have to go through the steps of explicitly filtering the results or writing extensive query strings. Using a conventional e-commerce system/content browser, a user would need to explicitly enter a query string such as “cars black sports convertible new porsche-carrera-rental-gt3-cayman” to get the same results as those that may be caused to be generated by the query refinement platform 103.

As discussed above, the query refinement platform 103 causes search results to be refined based on the user's detected interaction patterns. Conventional systems are limited in how search results may be refined. But, in the system 100, the detected interaction patterns and perceived interests based on those patterns are not limited to specific filtering options that conventional systems provide by way of pre-set user interfaces. Rather, any discernable pattern may indicate any user interest that may be formulated by the query refinement platform 103.

In another example, the search API 111 may be applicable to a user reviewing a spreadsheet that contains 50,000 lines of data entries such as historical purchase patterns of various consumers. The search API 111 may detect perceived patterns of user interactions with various data entries in the spreadsheet. The interactions may be any that are discussed above. In this example, the search API 111 may detect patterns such as scrolling patterns and the length of time a user remains within a particular view. The query refinement platform 103 may accordingly perceive such interaction patterns to indicate that the user is interested in data that includes entries exceeding $100 dollars and start to filter the 50,000 data entries down to those with a bill in excess of $100, for example. Further monitoring of the user's interactions may reveal patterns that indicate the user is looking for customers with a bill in excess of $100 that is more than three months past due. Again, the query refinement platform 103 may cause the list of 50,000 entries to be further refined to present those appropriate data entries.

In one or more embodiments, the discernable patterns may be communicated to the profile management service 107 for processing. As user patterns emerge, the profile management service 107 may establish various user preferences for particular topics or areas of interests and develop any number of user profiles that identify and assign these preferences to particular users. These profiles may be stored, for example, in database 109. Over time, the user profiles that are stored may be recalled, applied, and adjusted by the query refinement platform 103 in view of user interactions with content items to dynamically establish perceived user interests and search goals related to specific content items or topics that are unique from or similar to one another. Additionally, the profile management service 107 may consider user interaction patterns that relate to how a user interacts with search results once they are presented to a user regardless of any relation between content item topics. For example, if a user continually removes 10 items from a list of 20 that are returned as search results, the profile management service 107 may adjust the user preferences so that the query refinement platform 103 always returns 10 results for any content search. Or, for example, the user preferences may indicate a desire to adjust the number of returned results for a specific topic such as 10 results for a search related to cars, and 15 results for a search related to hotels.

The profile management service 107 may also share these profiles with the social networking service 113. Other users of UE 101's may develop preference profiles that indicate their particular interests in various content items and their own search preferences. The profile management service 107 may be caused by the query refinement platform 103 to match a user with other users of the system 100 and/or the social networking service 113 to further refine search results and develop the user's profile and preferences. For example, as a user develops his preference profile, and connects to other users by way of the social networking service 113, the profile management service 107 may process the connection to discern any similarities between the connected users.

In one or more embodiments, the profile management service 107 may process an indication of one or more other users' interests in the one or more content items or interests in various topics. The profile management service 107 may also determine similarities of one or more preferences of the one or more other users based on a comparison between the user's one or more preferences and one or more other users' one or more preferences. The profile management service 107 may also consider explicit user profile settings to determine a similarity between users, or any combination of any means for determining a reason to match one or more users together. The profile management service 107 may generate a determined degree of similarity between the user and one or more other users, and based on a threshold value, cause users that have a degree of similarity above that threshold value to be matched so that their preference profiles or search results may be refined. Then, based on the matching, the profile management service 107 causes the query refinement platform 103 to refine the scope of one or more search results presented to any of the users to be based on one or more preferences of any matched user.

For example, if the users are of a similar age, live in a same area, and have developed preferences that indicate a similar interest in cuisine, based on these similarities, the profile management system 107 may apply one user's interests in music to another user's preference profile to refine further searches that user may make related to music.

According to various embodiments, the profile management service 107 may also considered preferences of unconnected users that are matched based on comparisons of preference profiles and interests. Additionally, based on various preference profiles, if the users are not connected on the social networking service 113, the profile management service 107 may cause the social networking service 113 to suggest that the users having been matched connect to one another on the social networking service 113.

In one or more embodiments, the search API 111 may determine a user context by way of the UE 101. The query refinement platform 103 may cause any search results that are presented to the user to be further refined based on the determined user context.

For example, if a user is searching for cars while at a particular location, the query refinement platform 103 may present cars that are based on the user's perceived interests and available within a certain distance of the user's determined contextual location. This certain distance may be perceived based on the user's interactions with search results. For example, if the user has continually removed results for any topic (or specifically cars) that is determined to be 20 miles away, the query refinement platform may cause only results that are within 20 miles to be presented.

In one or more embodiments, the profile management service 107 may store a user's contextual patterns and apply these patterns to the user's preference profile so that searches may be refined based on the user's contextual patterns.

For example, if a user usually follows a certain path to work every day, this pattern may be stored in his user preference profile by the profile management service 107. At some point, the user runs a query to search for a place to buy clothes one morning before work. Based on historical user interactions, the query refinement platform may discern that the user has an interest in particular clothing brands perceived by processing mouse and/or viewing patterns, shopping habits, etc. The query refinement platform 103 may then discern the user's contextual patterns from his preference profile and return results that are applicable to his particular tastes and available on his path to work.

In one or more embodiments, the query refinement platform 103 may cause one or more types of interactions to be assigned one or more respective values that weights one or more types of interactions. Accordingly, any user preferences may be further based, at least in part, on the weighting of the one or more types of interactions. For example, one interaction such as a mouse hovering pattern may be weighted more heavily than another interaction such as a detected scrolling speed which may be weighted more heavily than another interaction such as a page up/down pattern. Then, based on the weighting, the query refinement platform 103 may discern a perceived user interest or preference based on the weighted values by assuming that a content item over which the user hovered his mouse was more important than content items that the user scrolled slowly through. The weighting may be set initially having default values, or initially having equal values in various embodiments. Over time, as the query refinement platform 103 discerns various interaction patterns and perceives particular user preferences, may cause these weights to change and be stored by the profile management service 107 as part of the user's preference profile.

In various embodiments, a user of the system 100 may be allowed the flexibility of either automatically accepting these detected patterns to be used to formulate his preference profile, or may be able to prompt explicit refinement of his profile by altering any perceived preference manually. For example, if the system 100 determines that the user likes dark colored cars, but the system was incorrect, the user may fix this error and adjust the preference profile to indicate the user likes red cars. From this point, the system 100 may further develop the user's preference profile so that it may more accurately reflect the user's preferences. Alternatively, a user may have an option to lock one or more perceived preferences so that it does not continually adapt over time. Further, a user may cause the various weights for various user interactions to be valued according to his particular settings and may also have an option to allow or disallow the profile management service 107 to communicate with the social networking service 113.

By way of example, the UE 101, query refinement platform 103, profile management service 107 and social networking service 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

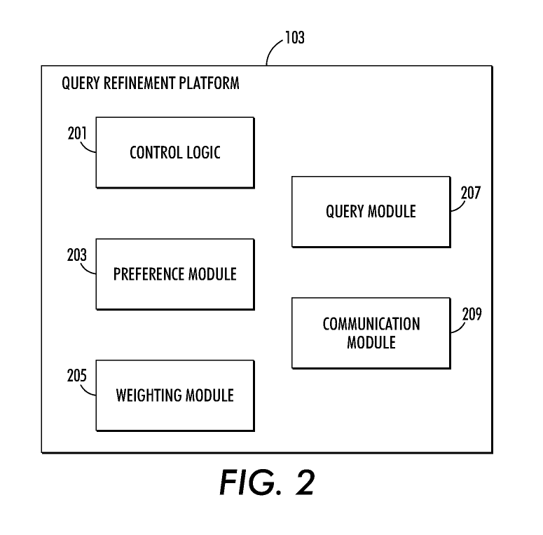

FIG. 2 is a diagram of the components of the query refinement platform 103, according to one embodiment. By way of example, the query refinement platform 103 includes one or more components for providing refined search results for a query based on one or more user interactions. It is contemplated that the functions of these components may be combined in one or more components or performed by other components of equivalent functionality. In this embodiment, the query refinement platform 103 includes a control logic 201, a preference module 203, a weighting module 205, a query module 207, and a communication module 209.

In one or more embodiments, the control logic 201 receives an indication from the search API 111 by way of the communication module 209 that a query for content has been entered or a spreadsheet requires refinement. The search API 111 having discerned user interaction patterns with content items viewable by way of UE 101 indicates to the query refinement platform 103 that these interactions have been detected. The control logic 201 instructs the preference module 203 to discern any patterns from the detected user interactions that may indicate any user preferences or interests related to various content items. The control logic 201 may also instruct the preference module 203 to communicate with the profile management service 107 by way of the communication module 209 to apply any user preference profile that may have one or more user preferences that may be used to further refine any results that may be presented for the query or to further refine the spreadsheet, for example, in accordance with those preferences.

The control logic 201 may then cause the weighting module 205 to weight any detected user interactions as discussed above to generate one or more perceived user interests or preferences based on the weighted user interactions. The weighting module 205 may also be caused to adjust weighting values as necessary to enable the user preference profile to be updated accordingly. Additionally, should any patterns be discerned from the detected user interactions, the preference module 203 may cause the profile management service 107 to further develop the user preference profile in view of any discerned patterns, updated weighting values, and perceived user preferences or interests.

The control logic 201 may then take any user preference whether it be based on a user preference profile, or instantaneous detected interactions, weighted as necessary, and instruct the query module 207 to refine any search results or refine what is presented on a spreadsheet in view of the perceived user preferences and communicate those results to the search API 111 by way of the communication module 209 so that they may be presented to a user of the UE 101.

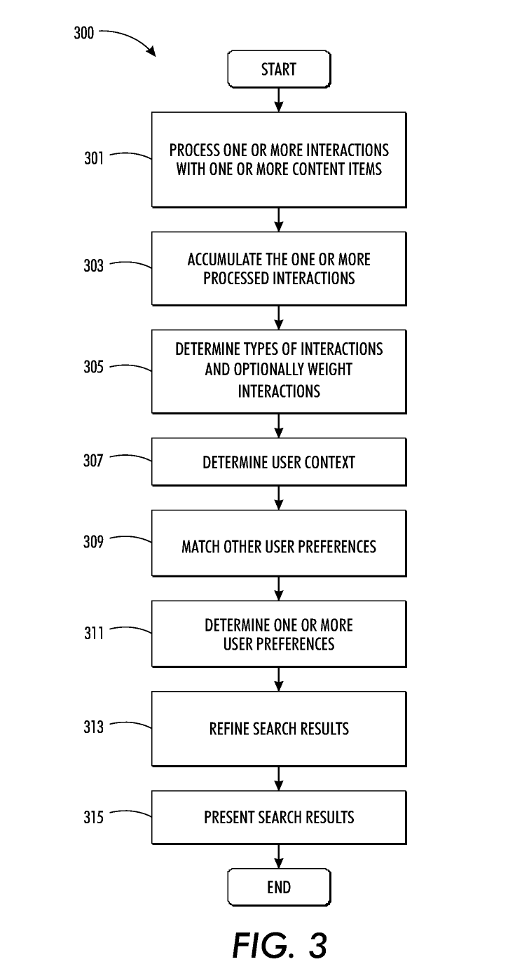

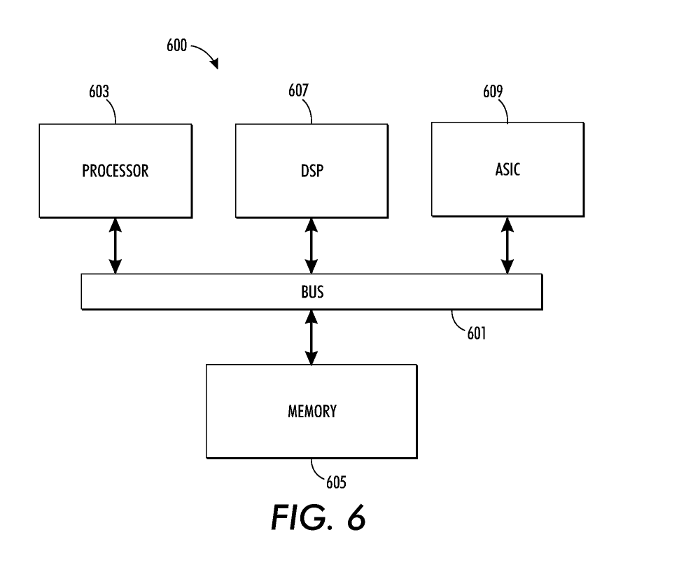

FIG. 3 is a flowchart of a process for providing refined search results for a query based on one or more user interactions, according to one embodiment. In one embodiment, the query refinement platform 103 performs the process 300 and is implemented in, for instance, a chip set including a processor and a memory as shown in FIG. 6. In step 301, the query refinement platform 103 processes one or more interactions of a user with one or more content items. Then, in step 303, the query refinement platform 103 causes, at least in part, an accumulation of the one or more interactions of the user.

Next, in step 305, the query refinement platform 103 determines one or more types of the one or more interactions. In one or more embodiments, the one or more types of interactions may comprise a scrolling speed of a display during a review of the one or more content items, a reviewing time of the one or more content items, a page up/page down pattern during a review of the one or more content items, a pointer pattern during a review of the one or more content items, an explicit direction to review the one or more content items, an explicit direction to ignore the one or more content items, a reviewing pattern of the one or more content items, an action to forward the one or more content items to another user, an action to favorite the one or more content items, an action to join a group related to the one or more content items, an action to select a coupon related to the one or more content items, or any combination thereof, for example. In one or more embodiments, the query refinement platform may assign one or more respective values that weights the one or more types of interactions.

The process continues to step 307 in which the query refinement platform 103 determines user context information. Next, in step 309, the query refinement platform 103 causes, at least in part, the profile management service 107, for example, to process an indication of one or more other users' interests in the one or more content items, the one or more other users' interests in topics related to the one or more content items, similarities of one or more preferences of the one or more other users based on a comparison between the user's one or more preferences and the one or more other users' one or more preferences, the one or more other users' profile settings, or any combination thereof to cause, at least in part, a generation of a degree of similarity between the user and the one or more other users. The one or more other users, for example, may be members of social networking service 113. The query refinement platform 103 then causes the user and at least one of the one or more other users to be matched based, at least in part, on the degree of similarity.

Then, in step 311 the query refinement platform 103 determines one or more user preferences based, at least in part, on the accumulated one or more interactions, the one or more types of interactions, the user context information, the one or more preferences of the matched one or more other users, and/or any determined interaction patterns based on the accumulated one or more interactions, etc. Next, in step 313, the query refinement platform 103 causes, at least in part, the scope of one or more search results for a query to be based, at least in part, on the one or more user preferences, the user context information, and/or the preferences of the one or more other users. The process continues to step 315 in which the query refinement platform 103 causes a presentation of the one or more search results to the user.

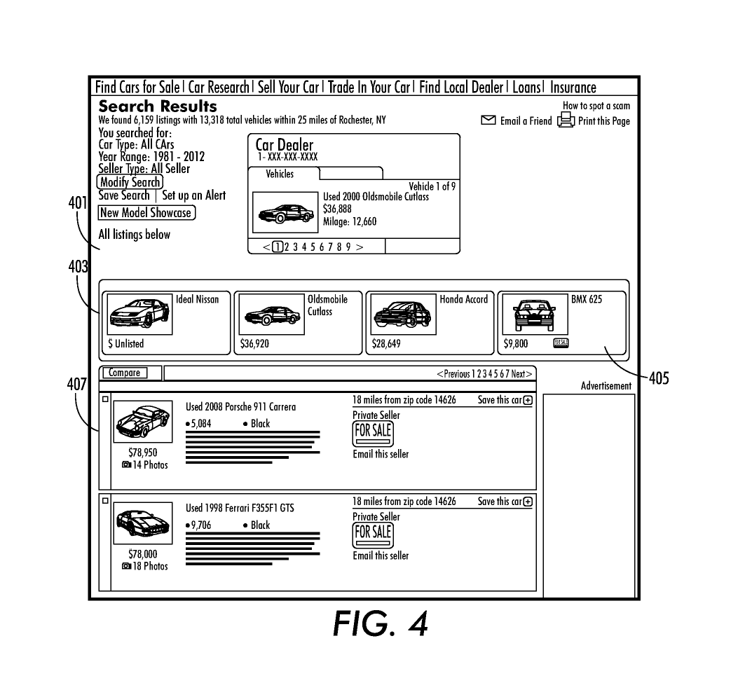

FIG. 4. is a diagram of a user interface utilized in the processes of FIG. 3, according to various embodiments.

For example, FIG. 4 illustrates an example user interface 401 that continuously updates presented search results as the user scrolls through search results for a query based on his perceived preferences. The search API 111, which as discussed above, may be a plugin for any browsing or content viewing application may detect a user interaction pattern as a user scrolls through results of the user interface 401 presented in response to a query for cars available for purchase by way of an e-commerce system. The search API 111 detects the speed at which the user scrolls through, or an amount that a user hovers over various content items. For example, the user may slow his scrolling at blue and black cars such as cars 403, but may seemingly ignore cars such as silver car 405. The search API 111 may send this information to the query refinement platform 103, and based on this information which would indicate the user is interested in blue and black cars over other colors, the query refinement platform 103 would further refine the query to return results that are directed to dark colored cars such as those presented in the lower section 407 of the user interface 401. For example, this further refinement may lead to only blue and black cars being presented to the user by the search API 111.

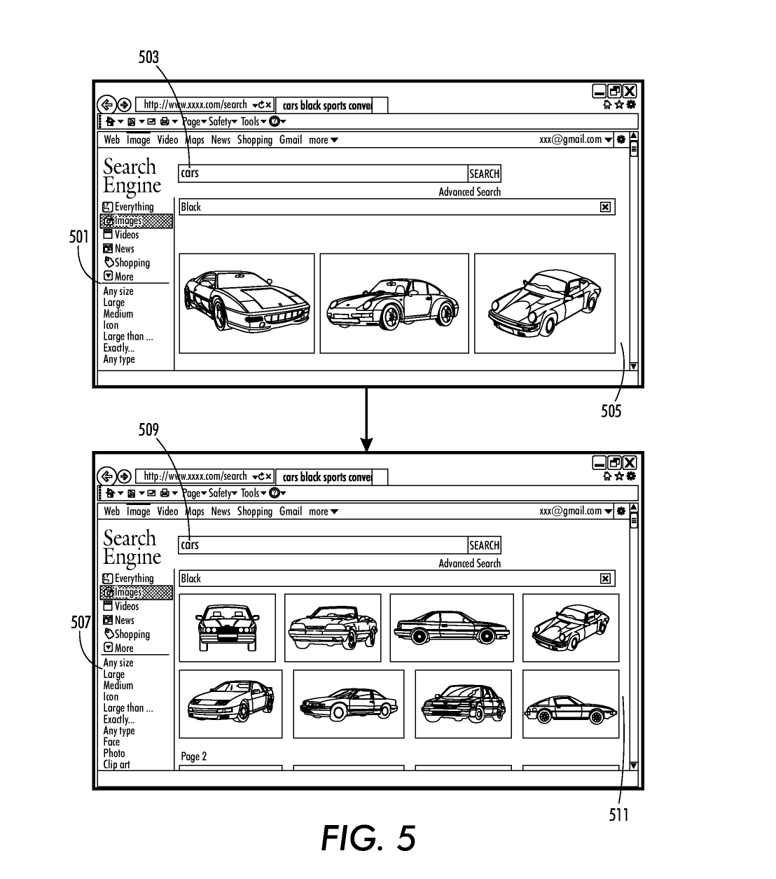

FIG. 5. is a diagram of a user interface utilized in the processes of FIG. 3, according to various embodiments.

As discussed above, any detected user interaction pattern may be considered in to indicate a user interest or preference for any topic that may further refine a search for a car, for example. The detected user interactions which may be used to develop a user preference profile may cause the query refinement platform 103 to perceive a user's preferences for domestic vs. foreign cars, dark colored cars vs. light colored cars, newer cars vs. older cars, convertible cars vs. hard top cars, sports car vs. sedan, etc. Based on the user's perceived combination of interests, results may be refined to the point that they would be in yield results in accordance with a specific query string such as “cars black sports convertible new porsche-carrera-rental-gt3-cayman.”

Accordingly, FIG. 5 illustrates a user interface 501 in which a user enters a generic query for “cars” in a field 503. Search results 505 may yield results for any car imaginable, any style, any color, etc., for example, if the search API 111 is not activated, or if there is no user preference profile or accumulated user interaction patterns applicable to cars.

But, if the search API 111 is activated in a user interface 507, and the query refinement platform 103 discerns a user interest based on an available user preference profile in particular cars, the query refinement platform 103 applies any applicable user preferences that may assist in providing results that interest the user. As such, based on the preferences determined, for example those discussed above in reference to FIG. 4, a generic search for “cars” 509 would yield results 511 that are in accordance with the perceived user preferences such as black sports cars that are convertible Porsches, for example. As such, the query refinement platform 103 causes search results to be refined based on the user's detected interaction patterns so that the user does not have to input extensive query strings or perform excessive explicit filtering steps in a conventional content browsing and/or e-commerce system.

The processes described herein for providing refined search results for a query based on one or more user interactions may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 6 illustrates a chip set or chip 600 upon which an embodiment may be implemented. Chip set 600 is programmed to provide refined search results for a query based on one or more user interactions as described herein may include, for example, bus 601, processor 603, memory 605, DSP 607 and ASIC 609 components.

The processor 603 and memory 605 may be incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing refined search results for a query based on one or more user interactions.

In one or more embodiments, the chip set or chip 600 includes a communication mechanism such as bus 601 for passing information among the components of the chip set 600. Processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one or more embodiments, the processor (or multiple processors) 603 performs a set of operations on information as specified by computer program code related to providing refined search results for a query based on one or more user interactions. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 601 and placing information on the bus 601. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 603, such as a sequence of operation codes, constitute processor instructions, also called computer system instructions or, simply, computer instructions. Processors may be implemented as mechanical, electrical, magnetic, optical, chemical or quantum components, among others, alone or in combination.

The processor 603 and accompanying components have connectivity to the memory 605 via the bus 601. The memory 605 may include one or more of dynamic memory (e.g., RAM, magnetic disk, writable optical disk, etc.) and static memory (e.g., ROM, CD-ROM, etc.) for storing executable instructions that when executed perform the inventive steps described herein to provide refined search results for a query based on one or more user interactions. The memory 605 also stores the data associated with or generated by the execution of the inventive steps.

In one or more embodiments, the memory 605, such as a random access memory (RAM) or any other dynamic storage device, stores information including processor instructions for providing refined search results for a query based on one or more user interactions. Dynamic memory allows information stored therein to be changed by system 100. RAM allows a unit of information stored at a location called a memory address to be stored and retrieved independently of information at neighboring addresses. The memory 605 is also used by the processor 603 to store temporary values during execution of processor instructions. The memory 605 may also be a read only memory (ROM) or any other static storage device coupled to the bus 601 for storing static information, including instructions, that is not changed by the system 100. Some memory is composed of volatile storage that loses the information stored thereon when power is lost. The memory 605 may also be a non-volatile (persistent) storage device, such as a magnetic disk, optical disk or flash card, for storing information, including instructions, that persists even when the system 100 is turned off or otherwise loses power.

The term “computer-readable medium” as used herein refers to any medium that participates in providing information to processor 603, including instructions for execution. Such a medium may take many forms, including, but not limited to computer-readable storage medium (e.g., non-volatile media, volatile media), and transmission media. Non-volatile media includes, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

While a number of embodiments and implementations have been described, the invention is not so limited but covers various obvious modifications and equivalent arrangements, which fall within the purview of the appended claims. Although features of various embodiments are expressed in certain combinations among the claims, it is contemplated that these features can be arranged in any combination and order.

What is claimed is:

1. A method comprising:
processing one or more interactions of a user with one or more content items to cause, at least in part, an accumulation of the one or more interactions of the user;
processing the accumulation of the one or more interactions to determine one or more interaction patterns;
determining one or more user preferences based, at least in part, on the one or more interaction patterns; and
causing, at least in part, a scope of one or more search results for a query to be based, at least in part, on the one or more user preferences.

2. A method of claim 1, further comprising:
causing, at least in part, a presentation of the one or more search results to the user.

3. A method of claim 1, further comprising:
determining one or more types of the one or more interactions; and
causing, at least in part, the one or more user preferences to be further based, at least in part, on the one or more types of interactions.

4. A method of claim 3, wherein the one or more types of interactions comprise a scrolling speed of a display during a review of the one or more content items, a reviewing time of the one or more content items, a page up/page down pattern during a review of the one or more content items, a pointer pattern during a review of the one or more content items, an explicit direction to review the one or more content items, an explicit direction to ignore the one or more content items, a reviewing pattern of the one or more content items, an action to forward the one or more content items to another user, an action to favorite the one or more content items, an action to join a group related to the one or more content items, an action to select a coupon related to the one or more content items, or any combination thereof.

5. A method of claim 3, wherein the one or more types of interactions are assigned one or more respective values that weights the one or more types of interactions, and the one or more user preferences are further based, at least in part, on the weighting of the one or more types of interactions.

6. A method of claim 1, further comprising:
determining user context information to cause, at least in part, the scope of one or more search results for a query to be further based, at least in part, on the user context information.

7. A method of claim 6, further comprising:
causing, at least in part, the one or more user preferences to be further based on the user context information.

8. A method according to claim 1, further comprising:
processing an indication of one or more other users' interests in the one or more content items, the one or more other users' interests in topics related to the one or more content items, similarities of one or more preferences of the one or more other users based on a comparison between the user's one or more preferences and the one or more other users' one or more preferences, the one or more other users' profile settings, or any combination thereof to cause, at least in part, a generation of a degree of similarity between the user and the one or more other users;
causing, the user and at least one of the one or more other users to be matched based, at least in part, on the degree of similarity; and
causing, at least in part, the scope of one or more search results to be further based on the one or more preferences of the matched one or more other users.

9. An apparatus comprising:
at least one processor; and
at least one memory including computer program code for one or more programs,
the at least one memory and the computer program code configured to, with the at least one processor, cause the apparatus to perform at least the following,
process one or more interactions of a user with one or more content items to cause, at least in part, an accumulation of the one or more interactions of the user;
process the accumulation of the one or more interactions to determine one or more interaction patterns;
determine one or more user preferences based, at least in part, on the one or more interaction patterns; and
cause, at least in part, a scope of one or more search results for a query to be based, at least in part, on the one or more user preferences.

10. An apparatus of claim 9, wherein the apparatus is further caused to:
cause, at least in part, a presentation of the one or more search results to the user.

11. An apparatus of claim 9, wherein the apparatus is further caused to:
determine one or more types of the one or more interactions; and
cause, at least in part, the one or more user preferences to be further based, at least in part, on the one or more types of interactions.

12. An apparatus of claim 11, wherein the one or more types of interactions comprise a scrolling speed of a display during a review of the one or more content items, a reviewing time of the one or more content items, a page up/page down pattern during a review of the one or more content items, a pointer pattern during a review of the one or more content items, an explicit direction to review the one or more content items, an explicit direction to ignore the one or more content items, a reviewing pattern of the one or more content items, an action to forward the one or more content items to another user, an action to favorite the one or more content items, an action to join a group related to the one or more content items, an action to select a coupon related to the one or more content items, or any combination thereof.

13. An apparatus of claim 11, wherein the one or more types of interactions are assigned one or more respective values that weights the one or more types of interactions, and the one or more user preferences are further based, at least in part, on the weighting of the one or more types of interactions.

14. An apparatus of claim 9, wherein the apparatus is further caused to:
determining user context information to cause, at least in part, the scope of one or more search results for a query to be further based, at least in part, on the user context information.

15. An apparatus of claim 15, wherein the apparatus is further caused to:
cause, at least in part, the one or more user preferences to be further based on the user context information.

16. An apparatus of claim 9, wherein the apparatus is further caused to:
process an indication of one or more other users' interests in the one or more content items, the one or more other users' interests in topics related to the one or more content items, similarities of one or more preferences of the one or more other users based on a comparison between the user's one or more preferences and the one or more other users' one or more preferences, the one or more other users' profile settings, or any combination thereof to cause, at least in part, a generation of a degree of similarity between the user and the one or more other users;
cause, the user and at least one of the one or more other users to be matched based, at least in part, on the degree of similarity; and
cause, at least in part, the scope of one or more search results to be further based on the one or more preferences of the matched one or more other users.

17. A computer-readable storage medium carrying one or more sequences of one or more instructions which, when executed by one or more processors, cause an apparatus to at least perform the following:
process one or more interactions of a user with one or more content items to cause, at least in part, an accumulation of the one or more interactions of the user;
process the accumulation of the one or more interactions to determine one or more interaction patterns;
determine one or more user preferences based, at least in part, on the one or more interaction patterns; and
cause, at least in part, a scope of one or more search results for a query to be based, at least in part, on the one or more user preferences.

18. A computer-readable storage medium of claim 17, wherein the apparatus is further caused to:
cause, at least in part, a presentation of the one or more search results to the user.

19. A computer-readable storage medium of claim 17, wherein the apparatus is further caused to:
determine one or more types of the one or more interactions; and
cause, at least in part, the one or more user preferences to be further based, at least in part, on the one or more types of interactions.

20. A computer-readable storage medium of claim 17, wherein the one or more types of interactions comprise a scrolling speed of a display during a review of the one or more content items, a reviewing time of the one or more content items, a page up/page down pattern during a review of the one or more content items, a pointer pattern during a review of the one or more content items, an explicit direction to review the one or more content items, an explicit direction to ignore the one or more content items, a reviewing pattern of the one or more content items, an action to forward the one or more content items to another user, an action to favorite the one or more content items, an action to join a group related to the one or more content items, an action to select a coupon related to the one or more content items, or any combination thereof.
